(19) United States
(12) Patent Application Publication
(10) Pub. No.: US 2014/0344945 A1
(43) Pub. Date: Nov. 20, 2014

(54) Thin-Client Embedded Secure Element

(71) Applicant: Broadcom Corporation, Irvine, CA (US)

(72) Inventors: Mark Buer, Payson, AZ (US); Mohamed Awad, Ladera Ranch, CA (US)

(73) Assignee: Broadcom Corporation, Irvine, CA (US)

(21) Appl. No.: 14/279,172

(22) Filed: May 15, 2014

Related U.S. Application Data
(60) Provisional application No. 61/823,908, filed on May 15, 2013.

(51) Int. Cl. G06F 21/60

(52) U.S. Cl. CPC G06F 21/606
USPC 726/26

(57) ABSTRACT

A thin-client embedded secure element, which includes a processor and a memory coupled to the processor, and a proxy client. The thin-client embedded secure element also includes a storage device including an identification uniquely identifying the thin-client secure element. The proxy client is configured to receive a request for the secured data from a module in the client device, establish a secure communication channel with a proxy server coupled to the computing device over a network, request the secured data from the proxy server using the identification, and provide the secured data to the module of the client device.

### CROSS-REFERENCE TO RELATED APPLICATIONS

The present invention claims the benefit of U.S. Provisional Application No. 61/823,908, filed May 15, 2013 (Attorney Docket No. 3875.7580000), which is incorporated herein by reference in its entirety.

### FIELD OF THE INVENTION

Embodiments of the present disclosure relate generally to the field of embedded data security.

### BACKGROUND

Computing devices, and in particular mobile computing devices, have increasing been used for performing transactions that require sensitive data. For example, mobile devices are increasingly being used to perform payment transactions, banking transactions, or to serve as a means for authentication. To protect the underlying sensitive data used in these transactions, manufacturers of such devices, have included a separate secure element for storing such data. The secure element provides an independent means from the rest of the computing device to store the sensitive data, thereby minimizing the possibility the sensitive data may be intercepted and use in an unauthorized manner. However, as the amount of transactions that use sensitive data grow, so too does the need for the storage capabilities of such secure elements to store sensitive data. But, this is at odds with the desire to maintain the small form factor of certain computing devices, particularly when space in such computing devices is already limited due to the expanding feature set of such devices. Therefore, what is needed is an improved secure element for storing large amounts of sensitive data.

### BRIEF DESCRIPTION OF THE DRAWINGS/FIGURES

Embodiments of the present disclosure are described with reference to the accompanying drawings. In the drawings, like reference numbers indicate identical or functionally similar elements. Additionally, the left most digit(s) of a reference number identifies the drawing in which the reference number first appears.

FIG. 1 is a diagram of a client device having a thin-client embedded secure element, according to an exemplary embodiment.

FIG. 2 is a diagram of an exemplary system having thin-client embedded secure element, according to an embodiment.

FIG. 3 is a flow diagram of a method for securing data using a thin-client embedded storage element, according to an exemplary embodiment.

FIG. 4 is an exemplary computing system in which embodiments may be implemented.

The invention will now be described with reference to the accompanying drawings. In the drawings, like reference numbers generally indicate identical, functionally similar, and/or structurally similar elements. The drawing in which an element first appears is indicated by the leftmost digit(s) in the reference number

### DETAILED DESCRIPTION OF THE INVENTION

The following Detailed Description refers to accompanying drawings to illustrate exemplary embodiments consistent with the present disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the present disclosure. Therefore, the Detailed Description is not meant to limit the present disclosure. Rather, the scope of the present disclosure is defined only in accordance with the following claims and their equivalents.

Embodiments of the present disclosure may be implemented in hardware, firmware, software, or any combination thereof. Embodiments of the present disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The following Detailed Description of the exemplary embodiments will so fully reveal the general nature of the present disclosure that others can, by applying knowledge of those skilled in relevant art(s), readily modify and/or adapt for various applications such exemplary embodiments, without undue experimentation, without departing from the spirit and scope of the present disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

### An Exemplary Client Device

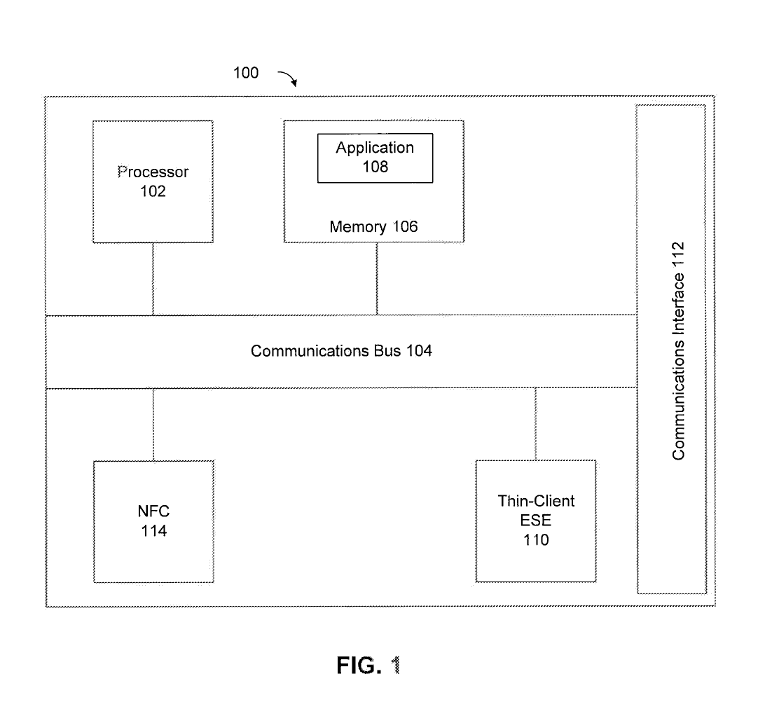

FIG. 1 is a diagram of a client device 100 having a thin-client embedded secure element, according to an exemplary embodiment. Client device 100 may be a personal computer, laptop, server, mobile device, tablet, embedded system, set-top box, access point, or any other type of computing device that uses secured data.

Client device 100 includes a processor 102, which may be any type of general purpose or special purpose processor. Processor 102 is coupled to a memory 106 over a communications bus 104, and configured to execute software instructions stored in memory 106. Memory 106 may be any type of any type of persistent or non-persistent computer readable storage medium including but not limited to, RAM, ROM, EPROM, EEPROM, flash memory, a magnetic storage medium, or an optical storage medium. Communications bus 104 may allow for both parallel and/or serial connections between devices and modules connected to communications bus 104. Processor 102 may also communicate with communications interface 112, thin-client embedded security element (ESE) 110, and near-field communications (NFC) device 114. NFC 114 may be configured to transmit or receive data over short distances with compatible devices. For example, NFC 114 may operate at 13.56 MHZ using the ISO/IEC 14000-3 standard air interface. Communications interface 112 may interface with any type of communications medium capable of transmitting data, including but not limited to, wireless mediums, hard-wired mediums, Ethernet, coaxial, optical, microwave, WiFi, Bluetooth, RFID, etc.

According to an exemplary embodiment, client device 100 is configured to use sensitive data in a secure transaction. For example the secure transaction may be a payment transaction, user authentication transaction, application authentication transaction, or any other transaction that requires sensitive data. In such a case, memory 106 may include instructions for an application 108. Application 108 may be software executed by processor 102 that uses the sensitive data. However, while FIG. 1 only depicts application 108, persons of ordinary skill in the art would appreciate that many applications could be stored and executing on client device 102. For example, application 108 may be used in a contactless payment transaction. In such a case, a user of client device 100 may use NFC 114 to wirelessly transmit payment to a point-of-sale terminal configured with an NFC receiver. Alternatively, such a transaction may be performed without application 108, and instead by NFC 114 alone. In any event, to perform the transaction, client device 100 may access payment tokens over a network, such as the Internet, or any other communications network. The payment tokens are typically encrypted and/or signed to prevent unauthorized use. However, the tokens must be decrypted before they are sent to the point-of-sale terminal. Accordingly, if the payment tokens are stored in memory 106 (in particular while unencrypted), they may be susceptible to interception or unauthorized use. While application 108 is described in an exemplary contactless payment transaction, a person of ordinary skill in the art would understand that application 108 can use sensitive data in a variety of circumstances, and that the sensitive data must be secured to prevent unauthorized use. Accordingly, client device 102 includes thin-client embedded secure element (ESE) 110, which prevents unauthorized use of sensitive data.

Thin-client ESE 110 emulates a secure element. For example, in an embodiment, thin-client ESE 110 is a secure element that appears to client device 102 as storing sensitive data locally, but the sensitive data may not actually be stored locally. Instead, thin-client device 102 may retrieve the sensitive data using communication interface 112 over a secure connection to a network. In this way, application 108, or any other module may communicate with thin-client ESE 110 as it would with a typical secure element that stores sensitive data. For example, application 108 may invoke one or more application programming interfaces (APIs) for communicating with a secure element. In such a case, application 108 and thin-client secure element may communicate using application data units (APDUs), or using any other suitable method of communication. As explained above, other modules such as NFC 114 may also interface with thin-client ESE 110 directly or indirectly to retrieve the sensitive data. For example, similarly to application 108, NFC 114 may communicate with thin-client ESE 110 using APDUs.

Thin-client ESE 110 may be a stand-alone component or may be integrated into another component (such as an NFC controller). Thin-client ESE 110 may be configured as a system on a chip (SoC), an integrated circuit (IC), an application specific integrated circuit (ASIC), a radio frequency integrated circuit (RFID), or any combination thereof

### An Exemplary Thin-Client Secure Element System

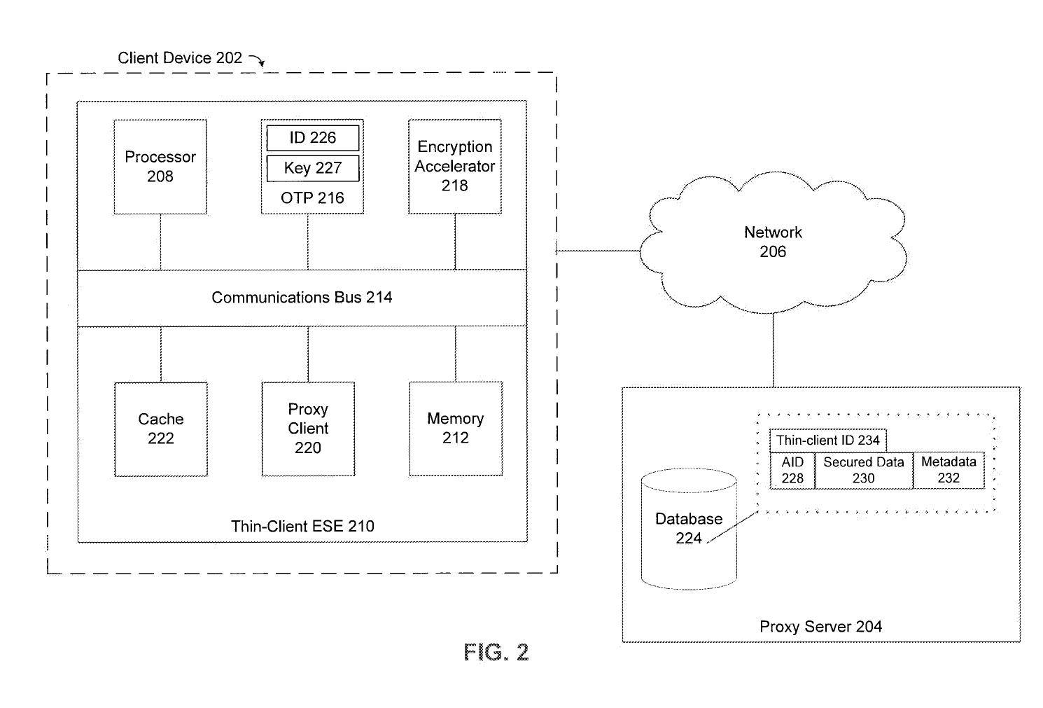

FIG. 2 is a diagram of an exemplary system 200 having thin-client embedded secure element (ESE), according to an embodiment. System 200 includes client device 202 and proxy server 204.

Proxy server 204 may be any type of computing device capable of securely storing data and communicating with one or more client devices 202. For example, proxy server 204 may be a personal computer, server, laptop, embedded device, or any other computing device. Proxy server 204 may be configured to store secured data 230 for client device 202. Secured data 230 may be any type of data that is sensitive, and thus needs to be stored securely. For example, secured data 230 may be a cryptographic key, a token used for payment, payment information, personal information, authentication information, or any other type of sensitive information.

Client device 202 includes a thin-client ESE 210. Thin-client ESE 210 may be configured to provide secured data 230 to client device 202 over a secure element interface. The secure element interface may be a standard interface for communicating with secure elements. For example, client device 202 may request secured data 230 from thin-client ESE 210 using an API defined for secure elements. In particular, client device 202 may request secured data from thin-client ESE 210 using APDUs. In this way, thin-client ESE 210 is configured to emulate a secure element to client device 202.

Thin-client ESE 210 includes a processor 208, which may be any type of general purpose or special purpose processor. Processor 208 is coupled to memory 212 over communications bus 214, and configured to execute software instructions stored in memory 212. In an exemplary embodiment, memory 212 may be read-only-memory (ROM), however, memory 212 may be any type of any type of persistent or non-persistent computer readable storage medium including but not limited to, RAM, ROM, EPROM, EEPROM, flash memory, a magnetic storage medium, or an optical storage medium. Communications bus 214 may allow for both parallel and/or serial connections between devices and modules connected to communications bus 214. Processor 208 may also communicate with an encryption accelerator 218, one-time-programmable memory 216, proxy client 220, and cache 222. It should be understood that while proxy client 220 is depicted as a separate hardware module, a person of ordinary skill in the art would understand, that proxy client 220 may be implemented in software, hardware, or a combination thereof. If proxy client 220 is implemented in software, it may comprise instructions stored in a memory, such as memory 212, or any other type of non-volatile memory.

Thin-client ESE 210 includes proxy client 220 for processing requests for secured data 230 and communicating with proxy server 204. In an exemplary embodiment, when client device 202 requests secured data 230, proxy client 220 may establish a secure communications channel with proxy server 204 to retrieve secured data 230. In particular, in an exemplary embodiment, thin-client ESE 210 does not itself contain any communication interfaces or mechanisms. Accordingly, proxy client 220 may use any of the communications interfaces and mechanisms available to client device 202 for establishing communications with proxy server 204. For example, proxy client 220 may be configured to use a TCP/IP protocol stack or a wireless radio of client device 202 to communicate with proxy server 204. Although, according to an exemplary embodiment, thin-client ESE 210 may also itself be configured with the necessary communications interfaces and mechanisms to communicate with proxy server 204.

Communications between proxy server 204 and thin-client ESE 210 over network 206 may be encrypted in a variety of ways. For example, proxy client 220 may be configured to use asymmetric or symmetric cryptography to secure communications with proxy server 204. In an exemplary embodiment, proxy client 220 may use secure socket layer (SSL) for communications with proxy server 204. Alternatively, proxy client 220 may be configured to use transport layer security (TLS) with proxy server 204. For example, the communications may be secured using Elliptic curve Cryptography. In an exemplary embodiment, proxy client 220 may be configured to use Elliptic curve Diffie-Hellman (ECDH) to perform a key exchange with proxy server 204. Proxy client 220 and proxy server 204 may also be configured to use ECDH with Elliptic curve Digital Signature Algorithm (ECDSA) for further authentication. Accordingly, using ECDH or ECDH-ECDSA, proxy client 220 and proxy server 204 may authenticate each other and agree on a master secret for use in encrypting their communications.

In an exemplary embodiment, thin-client ESE 210 may also include encryption accelerator 218 to assist in encryption or decryption of data. Encryption accelerator 218 may be any type of encryption accelerator that accelerates the encryption or decryption of data used in the communications between thin-client ESE 210 and proxy server 204. For example, encryption accelerator 218 may be an AES accelerator and/or an elliptic curve accelerator, or any combination thereof.

In an exemplary embodiment, thin-client ESE 210 may be pre-programmed with a cryptographic key 227 used to encrypt and/or authenticate its communications with proxy server 204. Cryptographic key 227 may include one or more public/private key pairs for asymmetric encryption, one or more keys for symmetric encryption, or any combination thereof. In addition, thin-client ESE 210 may also store a unique identification 226 used to establish its identity to proxy server 204. The cryptographic key 227 or identification 226 may be stored in one-time programmable memory (OTP) 216 within thin-client ESE 210. OTP 216 may be a non-volatile memory device that is configured to permit data to be written to it once, and then the data is permanently stored. Accordingly, cryptographic key 227 and identification 226 may be stored in OTP 216 permanently. In an exemplary embodiment, OTP 216 may be programmed at the factory with cryptographic key 227 and identification 226. However, the cryptographic key 227 and identification 226 may instead be generated when client device 202 is first powered-on, or first communicates with proxy server 204.

Thin-client ESE 210 may request secured data 230 from proxy server 204 in a number of circumstances, according to exemplary embodiments. For example, thin-client ESE 210 may request secured data 230 on-the-fly from proxy server 204. That is, thin-client ESE 210 may request secured data 230 from proxy server 204 when client device 202 asks thin-client ESE 210 for it. For example, in an exemplary contactless payment transaction, thin-client ESE 210 may contact proxy server 204 to access payment tokens or decryption keys for the payment tokens when a transaction is initiated. Similarly, for a user authentication or application authentication transaction, thin-client ESE 210 may contact proxy server 204 when a user authentication or application authentication transaction is initiated.

In an exemplary embodiment, thin-client ESE 210 may also include an optional cache 222. Cache 222 may be any type of volatile memory, for example RAM. Accordingly, secured data 230 may be erased if client device 202 resets or loses power. Cache 222 may be used to temporarily store secured data 230 within thin-client ESE 210. In that case, thin-client ESE 210 may request secured data 230 when client device 202 is powered-on or at a particular preset time or interval, and then store it in cache 222. For example, in a contactless payment transaction, thin-client ESE 210 may request pre-authorized payment tokens at preset intervals or when client device 202 is first powered-on. Alternatively, proxy server 204 may push secured data 230 to thin-client ESE 210 at preset intervals or when thin-client ESE 210 first contacts proxy server 204.

Thin-client ESE 210 may also be configured to store secured data 230 in cache 222 when client device 202 first requests it. Thus, the next time client device 202 requests secured data 230, thin-client ESE 210 may not need to communicate with proxy server 204, instead retrieving secured data 230 from cache 222. For example, in a user authentication or application authentication transaction, the first time client device 202 requires an authentication token to authorize a user or application, the token may be stored in cache 222 so that it does not need to be re-retrieved from proxy server 204 the next time it is needed by client device 202. Thus, if client device 202 loses connectivity to network 206, thin-client ESE 210 may still be able to provide access to secured data 230.

In an exemplary embodiment cache 222 may have limited storage for secured data to reduce the overall size of thin-client ESE 210. Accordingly, secured data 230 may only be stored in cache 222 for a limited period. For example, cache 222 may be configured to overwrite old data based on its length of time stored in cache 222. In such a case, if there was no or limited storage available in cache 222 when a new piece of secured data is to be stored, the new piece of secured data would overwrite the oldest piece of data stored in cache 222 first. Alternatively, data may be overwritten in cache 222 based on its priority or how often it is accessed.

Thin-client ESE 210 may also support a number of other operations in addition to requests for secured data 230. For example, thin-client ESE 210 may support a query operation, which lists all or part of secured data stored for a particular device or application. In such a case, thin-client ESE 210 would send a query request to proxy server 204 with the data that is to be queried, and proxy server 204 would return a list of secured data that matches that query. Thin-client ESE 210 may also support a delete operation and/or a modify operation for secured data 230, which would in turn be processed by proxy server 204. In addition, as would be understood by a person of ordinary skill in the art, there may be a number other operations that may also be supported by thin-client ESE 210 and proxy server 204 for operating on the secured data.

Proxy server 204 may store secured data 230 in any manner that is suitably secure. For example, proxy server may store secured data 230 in a database 224 using well-known cryptographic methods such as asymmetric or symmetric cryptography. Database 224 may be any type of database that supports secure storage of information, such as a database that supports SQL. In an exemplary embodiment, database 224 may correlate secured data 230 with an application ID (AID) 228 and a thin-client ID 234. Application ID 228 may identify a particular application that secured data 230 is used with or it may identify secured data 230 itself. Thin-client ID 234 may identify a particular client device based on a unique identification, such as identification 226. Accordingly, proxy client 220 may be configured to transmit identification 226 or an application ID so that proxy server 204 may query database 224 with identification 226 and/or an application ID to locate and return secured data 230 to proxy client 220.

In an exemplary embodiment, proxy server 204 may also store metadata 232 regarding secured data 230. Metadata 232 may be information regarding the status, type, and usage of secured data 230. Metadata 232 may be optionally transmitted to thin-client ESE 210 in response to its request for secured data 230. Metadata 232 may include usage information that describes the use of the secured data (i.e. payment token decryption, application authentication, credit card information, etc.). Metadata 232 may also contain security information that restricts the use of secured data 230. For example, in some cases, secured data 230 may only be used by certain applications or by certain hardware devices such as an NFC. In those cases, when thin-client ESE 210 received metadata 232 it would enforce any security restrictions as described in metadata 232. Metadata 232 may also include expiry information regarding secured data 230. The expiry information may be used to remove or disregard secured data in optional cache 222 once the expiry time has elapsed.

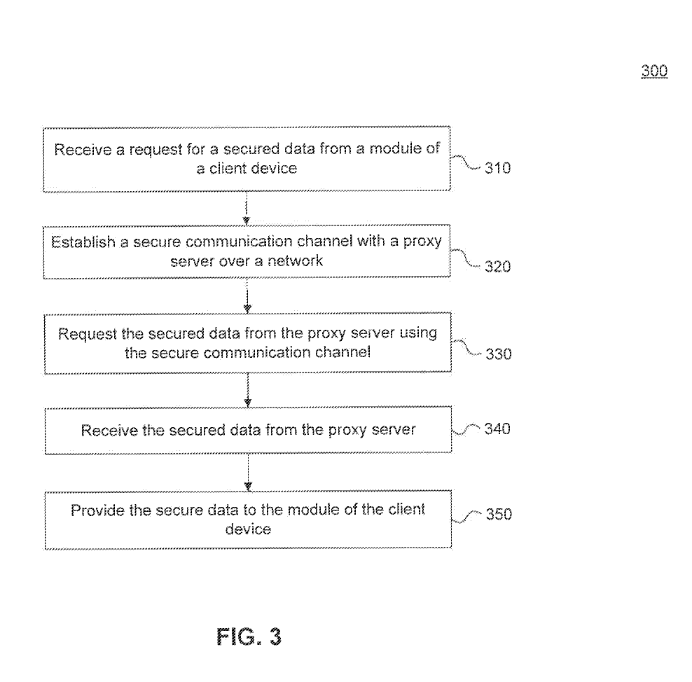

FIG. 3 is a flow diagram of a method 300 for securing data using a thin-client embedded storage element (ESE), according to an exemplary embodiment. FIG. 3 is described with reference to the embodiment of FIG. 2. However, method 300 is not limited to that embodiment.

At step 310 of method 300, a request is received for a secured data from a module of a client device. The module may be any type of hardware or software module located within the client device. For example, the module may be an NFC controller, such as NFC 114 of FIG. 1., or an application, such as application 108 of FIG. 1, The request may be received by a thin-client ESE, for example thin-client ESE 210 of FIG. 2 or thin-client ESE 110 of FIG. 1. More particularly, the request may be received using a standard interface for secure elements, such as application programming interface (API). The API may be defined by an operating system for interacting with secure elements. For example, the request may be in the form of an APDU. In an embodiment, other operations besides requests for secured data may also be received, such as query requests, delete requests, modify requests, or any other requests that may be used for secured data.

At step 320, a secure communication channel is established with a proxy server. The proxy server may be located remote from the client device over a network. The proxy server may store secured data for the client device. Secured data may be any type of data that is sensitive, and thus needs to be stored securely. For example, secured data may be a cryptographic key, a token used for payment, payment information, personal information, authentication information, or any other type of sensitive information.

The secure channel may be established in a variety of ways. For example, the channel may be established using TCP/IP and be configured to use asymmetric or symmetric cryptography to secure communications with the proxy server. In an exemplary embodiment, the channel may be secured using secure socket layer (SSL). Alternatively, the secure channel may also be secured with transport layer security (TLS). In particular, the communications may be secured using any suitable cryptographic technique such as Elliptic curve cryptography, Elliptic curve Diffie-Hellman, or Elliptic curve Digital Dignature Algorithm, or any combination thereof. For example, keys may be exchanged between the thin-client ESE and the proxy server using ECDH, and the proxy server and the thin-client ESE may authenticate each other using ECDSA.

The keys used to create the secure channel may be stored within the thin-client ESE and the proxy server. For example, the thin-client ESE may be pre-programmed with one or more cryptographic keys used to encrypt and/or authenticate its communications with the proxy server. The cryptographic keys may include one or more public/private key pairs for asymmetric encryption, one or more keys for symmetric encryption, or any combination thereof. In addition to the cryptographic keys, a unique identifier may also be stored within the thin-client ESE, which uniquely identifies the thin-client ESE. Either the cryptographic keys or unique identifier may be stored in a one-time programmable memory, such as OTP 216 in FIG. 2. In an exemplary embodiment, the cryptographic keys and unique identifiers may be programmed at the factory for a thin-client ESE. However, the cryptographic keys and unique identifier may instead be generated when the client device is first powered-on, or first communicates with the proxy server.

At step 330, the secured data is requested from the proxy server using the secure communication channel. The secured data may be requested from the proxy server in a number of circumstances, according to exemplary embodiments. For example, the secured data may be requested on-the-fly from the proxy server. That is, the secured data may be requested from the proxy server when the client device requests it from the thin-client ESE. However, in an exemplary embodiment, the thin-client ESE may also include an optional cache, such as cache 222 of FIG. 2. Accordingly, the secured data would be erased if the client device resets or is powered down. The cache may be used to temporarily store secured data. In that case, all secured data for a particular client device may be requested when the client device is first powered-on, or at a particular preset time or interval, and then stored in the cache. Alternatively, the secured data may also be stored in the cache the first time the secured data is requested. Thus, the next time a request is received for the same secured data, the secured data may not need to be retrieved from the proxy server, and instead the secured data may be retrieved from the cache. Thus, if client device loses connectivity to the network or the proxy server, the thin-client ESE may still be able to provide access to the secured data.

As explained above in FIG. 2, the proxy server may store the secured data in any manner that is suitably secure. For example, proxy server may store the secured data in a database using well-known cryptographic methods, such as a database. The database may correlate the secured data with an application ID and/or a thin-client ID. The application ID may identify a particular application the secured data is used with or it may identify the secured data itself. The thin-client ID may identify a particular client device for use with the secured data. Thus, when the secured data is requested from the proxy server, the request may comprise a unique identification for the client device or an application ID so that the proxy server may query the database to locate the secured data, and send it to the thin-client ESE.

At step 340, the secured data is received from the proxy server. The secured data may be sent back in any format that may be understood by a thin-client ESE. For example, in an exemplary embodiment, the secured data may be received in an APDU. Along with the secured data, metadata, such as metadata 232 of FIG. 2, describing the secured data may also be received, according to an exemplary embodiment. The metadata may be information regarding the status, type, and usage of the secured data. In particular, the metadata may include usage information that describes the use of the secured data (i.e. payment token decryption, application authentication, credit card information, etc.). The metadata may also contain security information, which restricts the use of the secured data. For example, in some cases, the secured data may only be used by certain applications or by certain hardware devices such as an NFC. In those cases, when the metadata is received, the security restrictions may be enforced by the thin-client ESE, as described in the metadata. The metadata may also include expiry information regarding the secured data. The expiry information may be used to remove or disregard secured data in optional cache once the expiry time has elapsed.

At step 350, the secured data is provided to the module of the client device. The secured data may be sent to the module of the client device using the standard secure element interface. For example, the secured data may be sent to the client device using an APDU. In an exemplary embodiment, the thin-client secure element may be located within an NFC controller, and thus in such a case, the secured data may be provided directly to the NFC. If metadata is received regarding the secured data, and the metadata includes security restrictions, the secured data is provided in accordance with those restrictions. For example, if the secured data is restricted to being sent to a particular application or a particular piece of hardware, such as an NFC, the secured data is only provided to those applications or pieces of hardware.

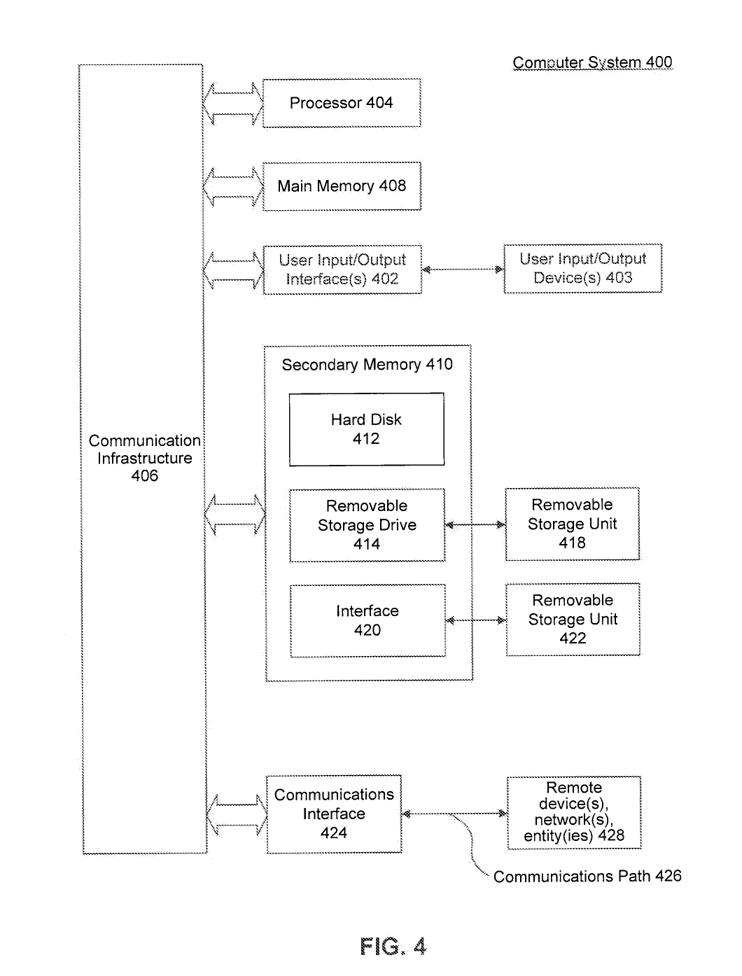

Various embodiments can be implemented, for example, using one or more well-known computer systems, such as computer system 400 shown in FIG. 4. Computer system 400 can be any well-known computer capable of performing the functions described herein, such as computers available from International Business Machines, Apple, Sun, HP, Dell, Sony, Toshiba, etc.

Computer system 400 includes one or more processors (also called central processing units, or CPUs), such as a processor 404. Processor 404 is connected to a communication infrastructure or bus 406.

One or more processors 404 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 400 also includes user input/output device(s) 403, such as monitors, keyboards, pointing devices, etc., which communicate with communication infrastructure 406 through user input/output interface(s) 402.

Computer system 400 also includes a main or primary memory 408, such as random access memory (RAM). Main memory 408 may include one or more levels of cache. Main memory 408 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, a solid-state drive (SSD) and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/or any other computer data storage device. Removable storage drive 414 reads from and/or writes to removable storage unit 418 in a well-known manner.

According to an exemplary embodiment, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 626, which may be wired and/or wireless, and which may include any combination of LANs, WANs, the Internet, etc. Control logic and/or data may be transmitted to and from computer system 400 via communication path 426.

In an embodiment, a tangible apparatus or article of manufacture comprising a tangible computer useable or readable medium having control logic (software) stored thereon is also referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), causes such data processing devices to operate as described herein.

### CONCLUSION

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

What is claimed is:

1. A thin-client embedded secure element comprising:
a processor;
a memory coupled to the processor;
a storage device configured to store an identification uniquely identifying the thin-client secure element; and
a proxy client configured to:
receive a request for secured data from a module of a client device;
establish a secure communication channel with a proxy server coupled to the client device;
request the secured data from the proxy server using the identification; and
provide the secured data to the module of the client device.

2. The thin-client embedded secure element of claim 1, further comprising a cache memory for temporarily storing the secured data.

3. The thin-client embedded secure element of claim 2, wherein the processor is configured to remove the secured data from the cache memory after predetermined time period.

4. The thin-client embedded secure element of claim 1, where in the predetermined time period is received from the proxy server.

5. The thin-client embedded secure element of claim 1, wherein the storage device is a one-time programmable memory.

6. The thin-client embedded secure element of claim 5, wherein the one-time programmable memory is further configured to store a cryptographic key used to establish the secure communication channel.

7. The thin-client embedded secure element of claim 1, wherein the processor is configured to establish the secure communication channel using asymmetric encryption.

8. The thin-client embedded secure element of claim 1, wherein the processor is configured to establish the secure communication channel using symmetric encryption.

9. A computing device for accessing secured data comprising:
a processor;
a memory coupled to the processor;
a secure interface; and
a thin-client embedded secure element coupled to the secure interface configured to:
receive a request for the secured data via the secure interface;
establish a secure communication channel with a proxy server coupled to the computing device over a network;
request the secured data from the proxy server; and
provide the secured data to the secure interface.

10. The computing device of claim 9, wherein the secure interface comprises an application programming interface for accessing secure elements.

11. The computing device of claim 9, wherein the thin-client embedded secure element further comprises a storage device including an identification uniquely identifying the thin-client secure element, and wherein the thin-client embedded secure element is further configured to request the secured data from the proxy server using the identification.

12. The computing device of claim 9, wherein the storage device is a one-time-programmable memory.

13. The computing device of claim 9, wherein the thin-client embedded secure element is further configured to temporarily store the secured data in a cache memory

14. The computing device of claim 13, wherein the thin-client embedded secure element is further configured to remove the secure data from the cache memory after predetermined time period.

15. The computing device of claim 14, wherein the predetermined time period is received from the proxy server.

16. A method for accessing secured data comprising:
receiving a request for a secured data from a module of a client device;
establishing a secure communication channel with a proxy server;
requesting the secured data from the proxy server; and
providing the secured data to the module of the client device.

17. The method of claim 16, further comprising temporarily storing the secured data in a cache memory.

18. The method of claim 17, further comprising:
receiving a second request for the secured data from a module of the client device:
determining whether the secured data is stored in the cache memory; and
providing the secured data stored in the cache memory to the module of the client device.

19. The method of claim 17, further comprising removing the secured data from the cache memory after a predetermined time period.

20. The method of claim 19, further comprising receiving the predetermined time period from the proxy server.

21. The method of claim 16, wherein the requesting the secured data further comprises:
requesting the secured data from the proxy server using a unique identifier.

22. The method of claim 16, wherein the module of the client device is a near-field communications device.
